(19) United States
(12) Patent Application Publication
(10) Pub. No.: US 2006/0261950 A1
(43) Pub. Date: Nov. 23, 2006

(54) Smart radio frequency identification (RFID) items

(75) Inventors: Michael R. Arneson, Finksburg, MD (US); William R. Bandy, Gambrills, MD (US)

Correspondence Address: STERNE, KESSLER, GOLDSTEIN & FOX PLLC, 1100 NEW YORK AVENUE, N.W., WASHINGTON, DC, 20005, US

(73) Assignee: Symbol Technologies, Inc., Holtsville, NY (US)

(21) Appl. No.: 11/391,294

(22) Filed: Mar. 29, 2006

Related U.S. Application Data
(60) Provisional application No. 60/665,879, filed on Mar. 29, 2005.

(51) Int. Cl. G08B 13/14

(52) U.S. Cl. 340/572.1; 340/572.8

(57) ABSTRACT

Methods, systems, and apparatuses for radio frequency identification (RFID) items/objects are described. In embodiments of the present invention, resonant frequency characteristics of materials of the items/objects are used to enable RFID functionality in the items/objects. In an aspect of the present invention, a RFID item comprises a resonant material. An integrated circuit (IC) die is electrically coupled to the resonant material. The resonant material functions as an antenna for the IC die. The IC die may be attached to a quadraposer substrate to be electrically coupled to the resonant material.

This application claims the benefit of U.S. App. No. 60/665,879, filed Mar. 29, 2005, which is herein incorporated by reference in its entirety.

### CROSS-REFERENCE TO RELATED APPLICATIONS

The following applications of common assignee are related to the present application, and are herein incorporated by reference in their entireties:

“Automated Real-Time Distributed Tag Reader Network,” Atty. Dkt. No. 1689.0010002, U.S. application Ser. No. 09/496,960, filed Feb. 3, 2000, now pending; and

“Method, System, And Apparatus For High Volume Assembly Of Compact Discs And Digital Video Discs Incorporating Radio Frequency Identification Tag Technology,” Atty. Dkt. No. 1689.0590000, U.S. application Ser. No. 10/866,151, now pending.

### BACKGROUND OF THE INVENTION

1. Field of the Invention

The present invention relates to radio frequency identification (RFID) technology, and more particularly, to using resonant frequency characteristics of materials to enable RFID functionality in items/objects.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond. Each tag stores a unique identification number. The tags respond to the reader transmitted signals by providing their identification number, bit-by-bit, so that they can be identified.

RFID tag and reader technology has many applications. For example, RFID tags and readers can be used to enhance retail “checkout” systems. In such systems, tags can be attached to items that are on sale. At checkout, by reading the tags, a reader can be used to identify the items a customer has selected for purchase, and a total cost for the items can be provided. The customer then pays for the items, and then removes the items from the store. Similarly, RFID technology is useful for tracking/identifying items in warehouse, factory, office, and other environments.

Eventually, it will be desired that many items will be identifiable and/or trackable using RFID technology. Thus, what is desired are methods, systems, and apparatuses for inexpensive and easily manufactured items incorporating RFID technology so that the items are trackable, identifiable, etc.

### BRIEF SUMMARY OF THE INVENTION

Methods, systems, and apparatuses for radio frequency identification (RFID) items/objects are described. In embodiments of the present invention, resonant frequency characteristics of materials of the items/objects are used to enable RFID functionality in the items/objects.

In an aspect of the present invention, a RFID item is described. The RFID items comprise a resonant material. An integrated circuit (IC) die is electrically coupled to the resonant material. The resonant material functions as an antenna for the IC die.

In one aspect, the IC die is directly coupled to the resonant material. In a further aspect, a matching network is used to match an impedance of the die to an impedance of the resonant material. The matching network may be located in the die, in/on the resonant material, between the die and resonant material, or any combination thereof.

In another aspect, the IC die is coupled to the resonant material through a substrate interface. The IC die and substrate form a quadraposer. In a further aspect, a matching network is used to match an impedance of the quadraposer to an impedance of the resonant material. The matching network may be located in the die, on the quadraposer substrate, in/on the resonant material, between the quadraposer and resonant material, or any combination thereof.

In another aspect of the present invention, a radio frequency identification (RFID) enabled item is formed. An item is optionally modified to enable antenna functionality. The item is characterized to determine an impedance characteristic. A matching circuit is determined. A quadraposer is formed. An impedance of the item is matched to an impedance of the quadraposer. The quadraposer is integrated with the item.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a plan view of an example radio frequency identification (RFID) tag.

FIG. 2 is a block diagram showing further example detail of a tag.

FIG. 3 shows a plan view of an example web of tags that is a continuous roll type.

FIG. 4A shows characteristic impedance equivalent circuits for an integrated circuit die/chip and an item.

FIGS. 4B-D show example matching networks that match impedances of the integrated circuit die and item of FIG. 4A, according to embodiments of the present invention.

FIG. 4E shows an example item/object with an RFID circuit attached thereto, according to an embodiment of the present invention.

FIG. 5A shows characteristic impedance equivalent circuits for an integrated circuit die/chip and a quadraposer substrate that form a quadraposer.

FIGS. 5B and 5C show example matching networks that match impedance of the quadraposer of FIG. 5A with an item, according to embodiments of the present invention.

FIG. 5D shows a view of an example substrate for an RFID quadraposer, according to an embodiment of the present invention.

FIGS. 6A-6C show views of quadraposer substrates, according to embodiments of the present invention.

FIG. 7 shows a cross-sectional view of a RFID chip attached to a quadraposer substrate to form a quadraposer, according to an embodiment of the present invention.

FIGS. 8A-8D show view of a quadraposer integrated with an item, according to example embodiments of the present invention.

FIG. 9 shows an example web containing a plurality of quadraposer substrates, according to an example embodiment of the present invention.

FIG. 10 shows a flowchart providing steps for forming an RFID tag enabled item, according to an example embodiment of the present invention.

FIG. 11 shows an example exploded diagram of internal components of an RFID cigarette pack, according to an example embodiment of the present invention.

FIG. 12 shows a foil layer of the RFID cigarette pack of FIG. 11, further showing a position for attachment of a quadraposer, according to an example embodiment of the present invention.

FIG. 13 shows a portion of a web of example quadraposer substrates, according to an embodiment of the present invention.

FIG. 14-21 shows examples of an RFID enabled items, according to embodiments of the present invention.

FIG. 22 shows an example quadraposer for optical storage devices, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to the application of radio frequency identification (RFID) functionality to items/objects. An RFID electrical circuit is attached to the item/object. The RFID circuit and item/object form a RFID enabled item/object (also referred to as an “RFID item/object” and an “RFID tag enabled item/object”) that can communicate with an RFID reader. The RFID enabled item/object is enabled with RFID tag functionality by the RFID electrical circuit. Thus, for example, the RFID item/object can receive interrogation signals from a RFID reader, and can respond to these interrogations. For example, the RFID circuit may respond with a stored identification number.

In embodiments, it is desired to manufacture/fabricate an item/object with RFID functionality. According to embodiments of the present invention, resonant characteristics of the item/object are determined, including a resonant frequency of the item/object. In an embodiment, the item/object may be modified to cause the item/object to have a desired resonant frequency, although this is not required.

In embodiments, the resonant characteristics of the item/object are used to create an antenna for the RFID item/object. The item/object may have a resonant material that is conventionally a portion (or all) of the item/object. Thus, in embodiments, the RFID circuit interfaces with the resonant material of the item to use the item, or portion thereof, as an antenna for the RFID enabled item/object. The RFID item/object transmits and receives communication signals via the created antenna. Embodiments of the present invention utilize the conventionally present resonant material in combination with the RFID circuit to create the RFID enabled device.

Incorporating RFID tags in items/objects at the time of manufacture is referred to as “source tagging.” Thus, embodiments of the present invention can be considered a form of source tagging, except that as opposed to conventional source tagging, a portion of the item/object forms an antenna for the RFID enabled item/object. As described herein, source tagging according to the present invention includes incorporating the RFID tag functionality at the time of manufacture directly into the item/object (and indirectly into the item/object by incorporating the RFID functionality into the packaging of the item/object). However, in further embodiments, the RFID tag functionality is incorporated into items/objects after their manufacture, and thus is not considered source tagging.

According to embodiments, any of a variety of items/objects may have RFID functionality incorporated therein. Note that the terms “items” and “objects” are used interchangeably herein. Example items/objects that may incorporate RFID functionality according to embodiments described herein include: compact discs (CDs), digital video discs (DVDs), and similar medium storing optical data; package/cartons for items such as cigarettes; wine and other beverage bottles; food cans and cans storing other materials; vitamin and medicine containers; other consumer product packaging; street and highway signs; shoes and other clothing; doors and doorways; light fixtures; house wiring; flooring; metal girders in buildings and bridges; windshields; statues; coins and currency; locking mechanisms; credit cards; cell phones; and any other item that incorporates a resonant material, such as a metal, metal foil, metallic films, metal fibers, inks, and/or other chemistries.

In embodiments, the RFID electrical circuit can include hardware, software, firmware, or any combination thereof, for communicating with a RFID reader. For example, the RFID electrical circuit may include a modulator, a demodulator, memory, and control logic, and may be implemented in one or more integrated circuit chips/dies. In embodiments, the RFID electrical circuit may interface with an item directly or indirectly through an interface means. In an embodiment, an interface means may include an impedance matching circuit (i.e., for matching the impedance of material of the item). The matching circuit may be formed in a conductive pattern, and may include further electrical elements, on a substrate. The RFID electrical circuit and interface means combination may also be referred to as an “quadraposer.” A “quadraposer” has four conductive segments. The RFID electrical circuit, with or without substrate interface, may also be referred to as a “RFID enabling circuit” or “RFID enabling circuit.”

An RFID electrical circuit can be attached to the RFID item/object with the appropriate coupling circuitry to enable communication with a reader according to any protocol, including binary protocols, Class 0, Class 1, Gen 2, and other protocols.

The item/object can be any item/object that includes a material that has resonant properties that enable it to serve as an appropriate antenna. For example, the item/object can be a potato chip bag, a window, a car windshield, a license plate, a boat, an electrical outlet/structural wiring, metal (e.g., copper) tubing in a building, etc. For illustrative purposes, the present invention is described below with regard to an RFID cigarette pack embodiment, and other example embodiments. However, the present invention is not limited to these embodiments. Further embodiments will be apparent to persons skilled in the relevant art(s) from the teachings herein, including embodiments related to the item/objects mentioned above, and any other items/objects. These further embodiments are within the scope and spirit of the present invention.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “left,” “right,” “up,” “down,” “top,” “bottom,” “vertical,” “horizontal,” etc.) used herein are for purposes of illustration only, and that practical implementations of the structures described herein can be spatially arranged in any orientation or manner.

Example RFID Tags

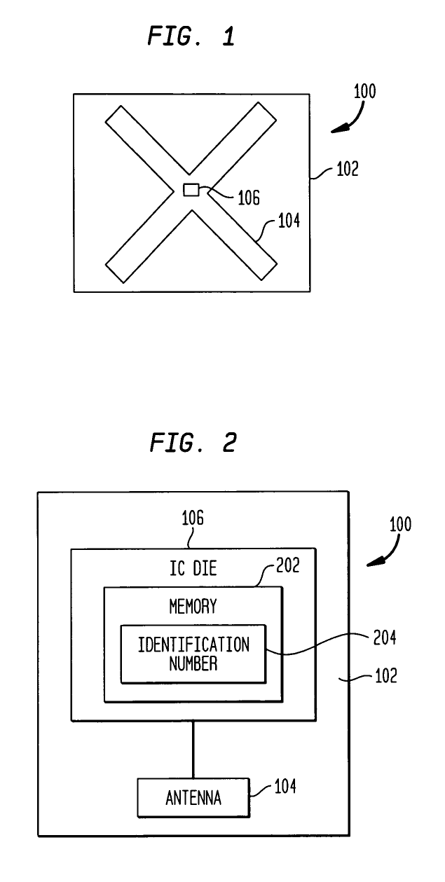

FIG. 1 shows a plan view of an example radio frequency identification (RFID) tag 100. Tag 100 includes a substrate 102, an antenna 104, and an integrated circuit (IC) 106. Antenna 104 is formed on a surface of substrate 102. Antenna 104 may include any number of one or more separate antennas, including a dipole antenna, a patch antenna, a slot antenna, and other antenna types. IC 106 includes one or more integrated circuit chips/dies, and can include other electronic circuitry. IC 106 is attached to substrate 102, and is coupled to antenna 104 by way of bonding pads on die 106 and substrate 102 which correspond to terminals of antenna 104. IC 106 may be attached to substrate 102 in a recessed and/or non-recessed location. IC 106 controls operation of tag 100, and transmits signals to, and receives signals from RFID readers using antenna 104. Tag 100 may additionally include further elements, including an impedance matching network and/or other circuitry.

FIG. 2 shows a block diagram providing further example detail of tag 100. As shown in FIG. 2, integrated circuit 106 of tag 100 includes a memory 202, which may be a non-volatile memory, for example. Memory 202 stores data, including an identification number 204. Identification number 204 typically is a unique identifier (at least in a local environment) for tag 100. For instance, when tag 100 is interrogated by a reader (e.g., receives an interrogation signal), tag 100 may respond with identification number 204 to identify itself. Identification number 204 may be used by a computer system to associate tag 100 with its particular associated object/item.

Readers transmit interrogation signals having a carrier frequency to populations of tags 100. Readers typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 100 may be present in a tag population that transmit one or more response signals to an interrogating reader, including by alternatively reflecting and absorbing portions of the interrogation signal (e.g., the carrier frequency) according to a time-based pattern or frequency. This technique for alternatively absorbing and reflecting an interrogation signal is referred to herein as backscatter modulation. Readers receive and obtain data from the tag response signals, such as the identification number 204 of the responding tag 100. In the embodiments described herein, tags 100 may be capable of communicating with readers according to any suitable communication protocol, including Class 0, Class 1, EPC Gen 2, other binary traversal protocols and slotted aloha protocols, any other protocols mentioned elsewhere herein, and future developed communication protocols.

In embodiments, tags, such as tags having elements of the structure and/or functionality of tag 100, are integrated with items/objects, utilizing a material of the items/objects. For example, a material of an item/object may function as a portion or all of an antenna (e.g., antenna 104) of the tag. Thus, an RFID structure formed according to embodiments of the present invention, such as a “quadraposer,” may be applied (e.g., attached) to an item/object to incorporate RFID functionality into the item/object. In an embodiment, the RFID structure includes an RFID circuit, such as IC 106.

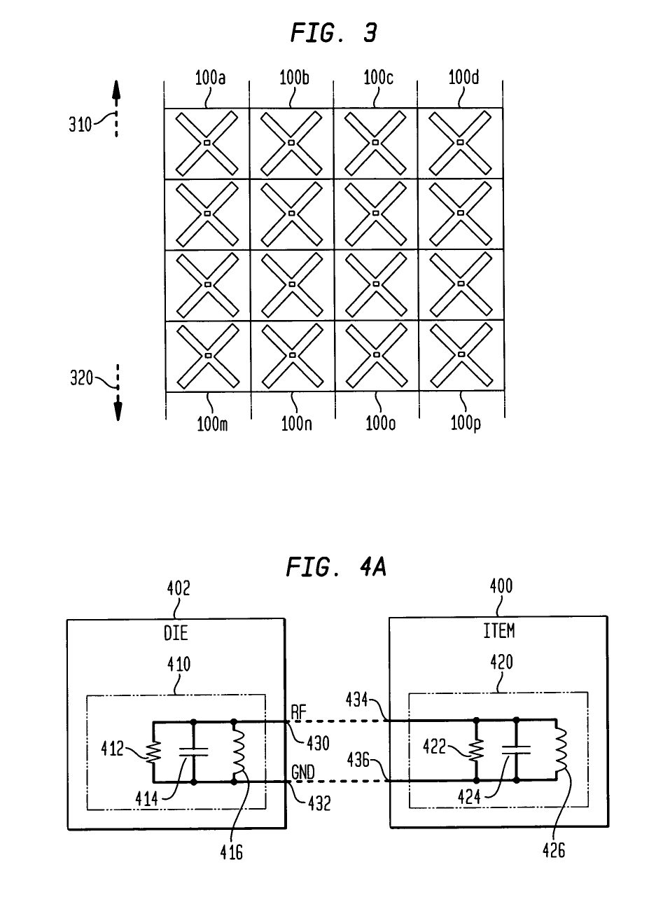

Tags, such as tag 100, may be assembled in large quantities. For example, volume production of RFID tags, such as tag 100, is typically accomplished on a printing web based system. In such a system, tags may be assembled in a web of substrates, which may be a sheet of substrates, a continuous roll of substrates, or other group of substrates. For instance, FIG. 3 shows a plan view of an example web 300 that is a continuous roll type. As shown in FIG. 3, web 300 may extend further in the directions indicated by arrows 310 and 320. Web 300 includes a plurality of tags 100a-p. In the example of FIG. 3, the plurality of tags 100a-p in web 300 is arranged in a plurality of rows and columns. The present invention is applicable to any number of rows and columns of tags, and to other arrangements of tags.

In embodiments, the RFID structures (e.g., quadraposers) that may be applied to items/objects may be formed in high volumes in a web based system, or other system for forming tags in high volume. Furthermore, the RFID structures may be incorporated in the items/objects during manufacture of the items/objects, or after manufacture of the items/objects (e.g., by hand or by automated process). For example, labels for items (such as cans or bottles) may be formed in high volume sheets (similar to web 300). The RFID structures of the embodiments described herein may be attached to/formed in the labels during their manufacture. Thus, the labels incorporating the RFID structures could then attached to the items/objects as is conventionally done, or in a modified manner.

Example Embodiments for RFID Items/Objects

According to embodiments of the present invention, items/objects have RFID functionality incorporated therein, by attachment of an RFID enabling structure, such as a quadraposer.

In an example embodiment, resonant characteristics of the item/object may be determined, including a resonant frequency of the item/object. The item/object may be modified to cause the item/object to have a desired resonant frequency, if desired, and provide physical coupling structures for the RFID chip. An RFID circuit is attached to the item/object via the appropriate coupling structure. The RFID circuit and item/object form a RFID item/object that can communicate with an RFID reader. Thus, for example, the RFID item/object can receive interrogation signals from the reader, and can respond to these interrogations, such as by responding with a stored identification number. The RFID item/object can have any RFID tag functionality.

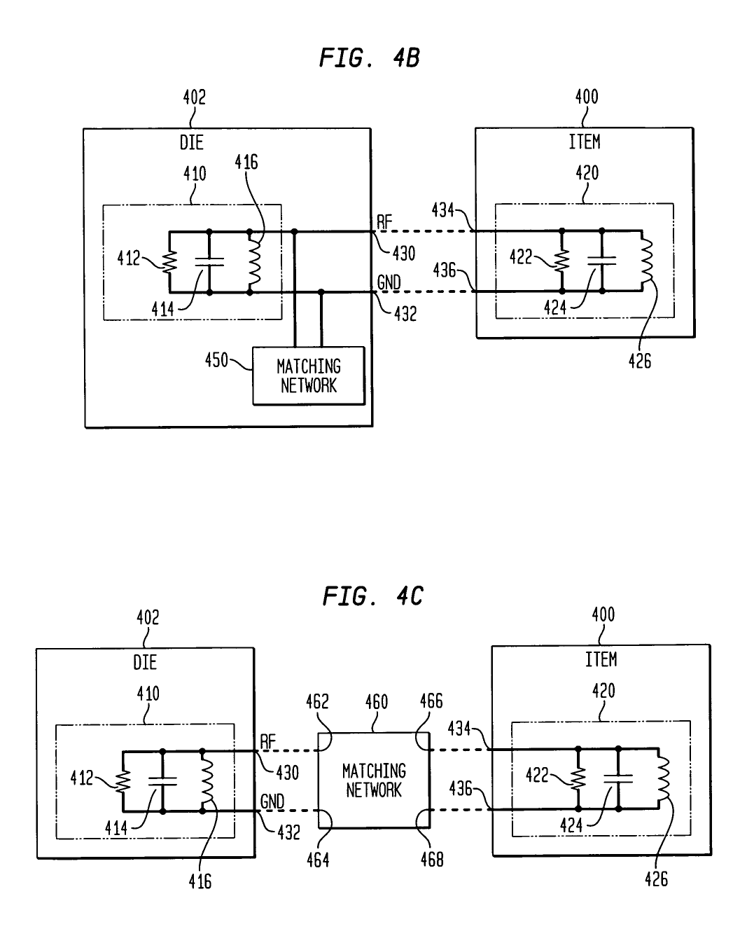

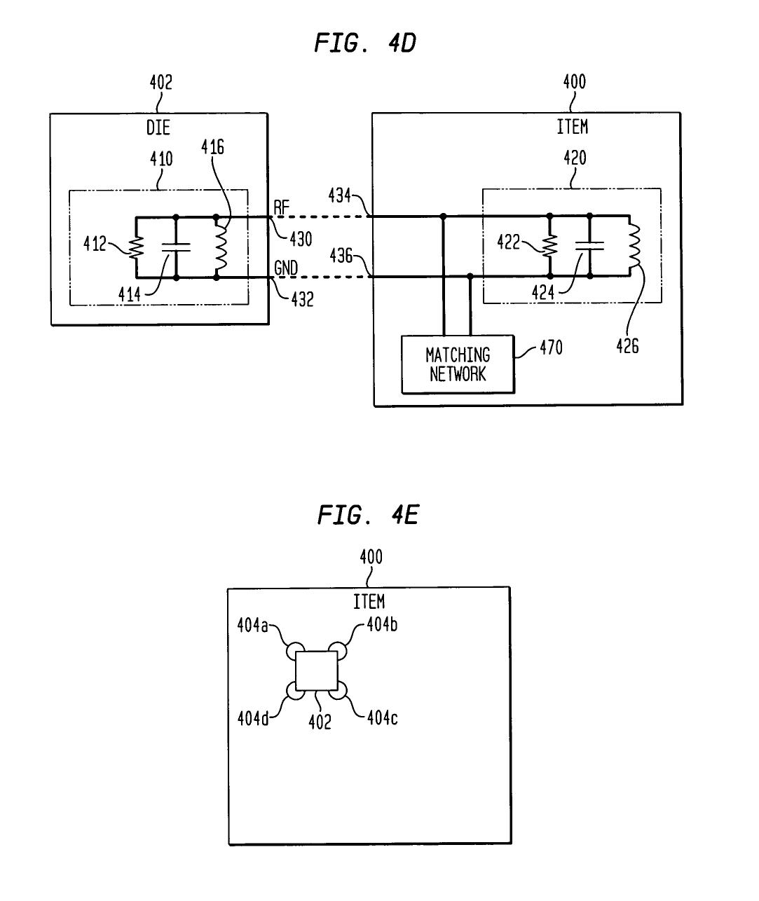

For example, FIG. 4A shows characteristic impedance equivalent circuits 410 and 420, for an integrated circuit die/chip 402 and an item 400, respectively. For example, circuit 420 may be an equivalent circuit for a resonant material of item 400 to which circuit 420 is attached. Circuit 410 of chip 402 includes an equivalent resistance 412, equivalent capacitance 414, and equivalent inductance 416, coupled in parallel. Circuit 420 of item 400 includes an equivalent resistance 422, equivalent capacitance 424, and equivalent inductance 426, coupled in parallel. Although shown in FIG. 4A with parallel coupled equivalent elements, for illustrative purposes, equivalent circuits 410 and 420 may alternatively be shown as having series coupled equivalent elements.

Circuit 410 of chip 402 is coupled across an RF port 430 and a ground port 432 of chip 402. RF port 430 and ground port 432 of chip 402 may be pads accessible externally on chip 402. RF port 430 and ground port 432 of chip 402 respectively couple to coupling points 434 and 436 of item 400, when chip 402 is attached to item 400. The impedances of equivalent circuits 410 and 420 need to closely match for the resonant material represented by equivalent circuit 420 to operate as an effective antenna for chip 402.

Note that a single RF port 430 is shown for chip 402 in FIG. 4A. However, in further embodiments, chip 402 may be configured to couple to multiple antennas (of item 400), including two antennas. Thus, in embodiments, chip 402 may have additional RF ports. Each additional RF port has its own equivalent circuit 410.

The resonant frequency of a circuit (e.g., either of circuits 410 and 420) is:
ωₒ=1/sqrt(LC)(where ωₒ is in radians); or
f₀=ωₒ/2π=(where fₒ is in degrees).

where:
L=equivalent inductance value, and
C=equivalent capacitance value.

The equivalent circuit of a material will be a distributed RLC network, with an equivalent series circuit having a Q value as follows:
Qₒ=(1/R)*sqrt(L/C) Equation 1

where:
R=equivalent resistance value.

Note that if the equivalent resistance 422 (R) of a material of item 400 is very large, Q will be very small, and in some circumstances not enough voltage will be achieved across the equivalent circuit to operate chip 402. Thus, the material of item 400 may need to be modified to provide a lower equivalent resistance 422 for the material.

An equivalent series circuit for the material of item 400 has the following impedance:
Za=Ra+jXa Equation 2

where:
Xa is the reactive part of the impedance due to its capacitance and inductance values, and
Ra=Rr+Rd=equivalent resistance of antenna/material

where:
Rd=dissipative resistance, and
Rr=radiation resistance of the antenna/material.
   The radiation resistance (Rr) is a mathematical function of the specifics of the antenna/material configuration, and the dissipative resistance (Rd) is due to a parasitic resistance in the material/antenna circuit. Chip 402, which in this case is the “load”, has an impedance based on its effective resistance and reactance as follows:
   Z_{L}=R_{L}+jX_{L}. Equation 3

An antenna efficiency for chip 402 coupled to item 400 is as follows:
Ea=4RrR_{L}/[(Rr+Rd+R_{L})²+(Xa+X_{L})²]. Equation 4

To maximize antenna efficiency, the following parameters should be set (as closely as possible):
Xa=−X_{L}, and Equation 5
R_{L}=Rr+Rd. Equation 6
In an embodiment, an impedance matching network, also referred to as a matching circuit, is used to enable Equations 5 and 6 to be closely met. When the impedance matching network, enables Equations 5 and 6, Equation 4 can be rewritten as follows:
Ea=Rr/(Rr+Rd). Equation 7
So antenna efficiency, Ea, is maximized through the use of impedance matching, minimizing dissipative resistance, Rd, by substantially eliminating parasitic antenna resistance, and maximizing radiation resistance, Rr, through effective antenna design.

For a material of item 400 to serve as an efficient antenna, it should have a relatively low resistance. Thus, if required, a structure of the item 400 may be modified to lower its resistance, and to tune its effective inductance L and effective capacitance C to achieve the desired value of resonant frequency, ωₒ, and to maximize radiation resistance, Rr. Alternatively, in some embodiments, the structure of item 400 does not need to be modified.

According to embodiments, a matching network is incorporated in chip 402 and/or in item 400 to achieve Equation 5 (Xa=−XL) and Equation 6 (R_{L}=Rr+Rd). The matching network enables a matching of the impedance of chip 402 with an impedance of item 400 (at a mount point in/on item 400). When this is achieved, the material of item 400 will serve as a reasonably efficient antenna for RFID chip 402.

FIGS. 4B-D show example matching networks that match impedances of die 402 and item 400, according to embodiments of the present invention. For example, FIG. 4B shows a matching network 450 incorporated in chip 402. Matching network 450 has an impedance that modifies an effective impedance of chip 402, so that an impedance of chip 402 across ports 430 and 432 matches an impedance of item 400 between points 434 and 436. Thus, matching network 450 may include one or more resistive elements, one or more capacitive elements, one or more impedance elements, or any combination thereof, to provide a desired impedance. For example, matching network 450 may include a bank of resistors and/or capacitors that are controlled by switches. The switches may be set in a particular configuration to cause matching network 450 to have a desired impedance value.

In an embodiment, matching network 450 is a smart matching network circuit. In such an embodiment, after chip 402 is attached to item 400, matching network 450 senses an impedance between ports 430 and 432, and tunes/adjusts its internal impedance to output an impedance at ports 430 and 432 that matches the impedance of item 400.

FIG. 4C shows a matching network 460 coupled between chip 402 and item 400. First and second ports 462 and 464 of matching network 460 are coupled to ports 430 and 432 of die 402, respectively. Third and fourth ports 466 and 468 of matching network 460 are coupled to points 434 and 436 of item 400, respectively. Matching network 460 is configured such that chip 402 and matching network 460 have a combined impedance that matches an impedance of item 400 (at points 434 and 436). Matching network 460 may be a circuit board, a chip/die, or other device or medium coupled between chip 402 and item 400.

Matching network 460 may be configured in any manner to provide a desired impedance, such as similarly to matching network 450 of FIG. 4B. For example, matching network 450 may include a bank of resistors, capacitors, and/or inductors mounted to a board. Matching network 450 may include one or more circuit traces having selected lengths, widths, and/or thicknesses, to provide a desired impedance. The traces may be trimmed (i.e., have metal removed), have slots formed therein, etc., to tune an impedance of matching network 450.

FIG. 4D shows a matching network 470 coupled in/on item 400. Matching network 470 is configured such that chip 402 and matching network 470 have a combined impedance that matches an impedance of item 400 (at points 434 and 436). Matching network 470 may be a circuit board, a chip/die, or other device or medium coupled in/on item 400. Matching network 470 may be configured in any manner to provide a desired impedance, such as similarly to matching networks 450 and 460 described above.

FIG. 4E shows an example item 400 having an RFID circuit chip 402, according to an embodiment of the present invention. In the example of FIG. 4E, chip 402 has four input/output pads (not visible in FIG. 4E), with each pad coupled to a respective one of four landing pads 404a-404d of item 400 (also not visible in FIG. 4E). In alternative embodiments, chip 402 may have numbers of pads other than four, including fewer pads and additional pads. Chip 402 is integrated with (e.g., attached to, mounted on, formed in, etc.) item 400, to provide item 400 with RFID tag functionality, as described above.

Item 400 may have bonding areas/points/pads formed therein/thereon, to provide a mounting point for chip 402, such as coupling points 434 and 436 described above. Chip 402 may be attached to the bonding pads of item 400 in a variety of ways, including by solder, an adhesive material, including an electrically conductive adhesive (including an anisotropic adhesive, such as a Z-axis conductive adhesive), etc. Capacitive coupling attachment of the pads of chip 402 to item 400 eliminates the need for conductive adhesives between the pads of chip 402 and landing areas on item 400, making it much easier to attach chip 402 to item 400.

Chip 402 may be integrated with item 400 during a manufacturing process for item 400, or after conventional manufacturing of item 400 is complete. For example, chip 402 could be mounted to item 400 using a “pick and place” attachment mechanism, using vision-based positioning or other types of positioning systems. Alternatively, a plurality of chips 402 could be mounted to multiple items 400 in a parallel assembly system. Example high volume assembly techniques applicable to embodiments of the present invention are described in U.S. application Ser. No. 10/429,803, titled “Method And System For Forming A Die Frame And For Transferring Dies Therewith,” now pending, and U.S. application Ser. No. 10/866,159, titled “Method, System, And Apparatus For Transfer Of Dies Using A Pin Plate,” now pending, which are both herein incorporated by reference in their entireties.

In another embodiment, chip 402 may be attached to an intermediate substrate to enhance attachment to item 400. For instance, attachment to an intermediate substrate may make easier the attachment of chip 402 to item 400 because the intermediate substrate may effectively spread out and/or enlarge the pads of chip 402 (likewise, allowing landing pads 404a-404d to be spread out and/or enlarged, when present), so that less precise means are necessary for attachment to item 400. Furthermore, the intermediate substrate may allow attachment to item 400 by hand, if desired.

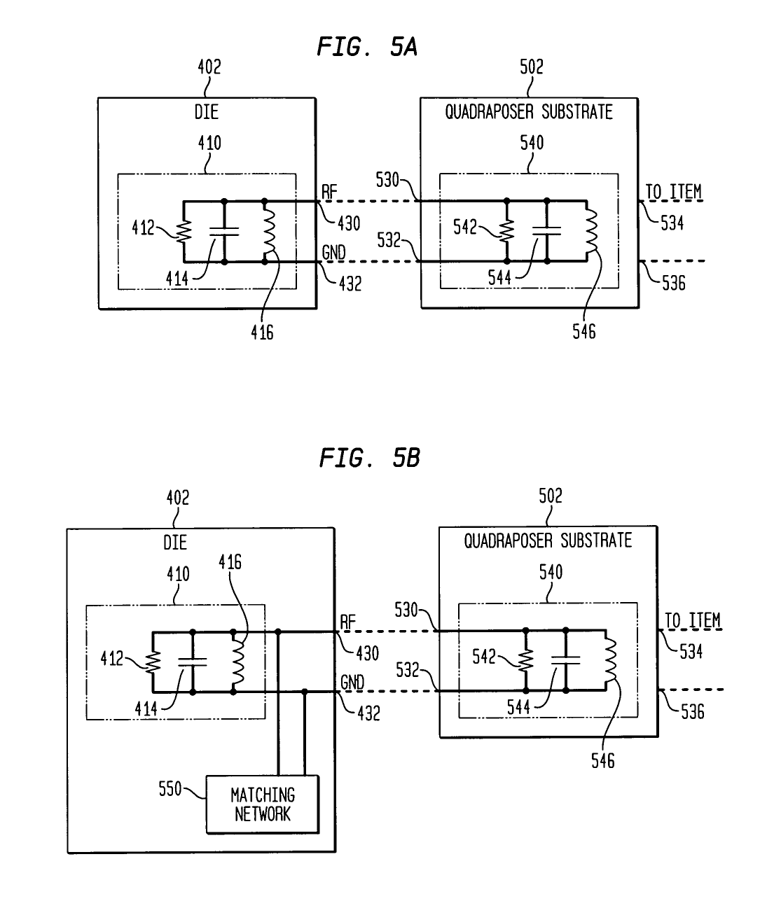

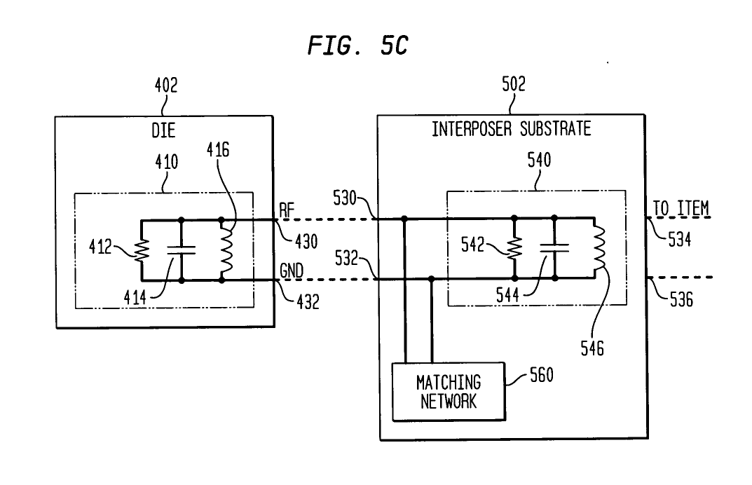

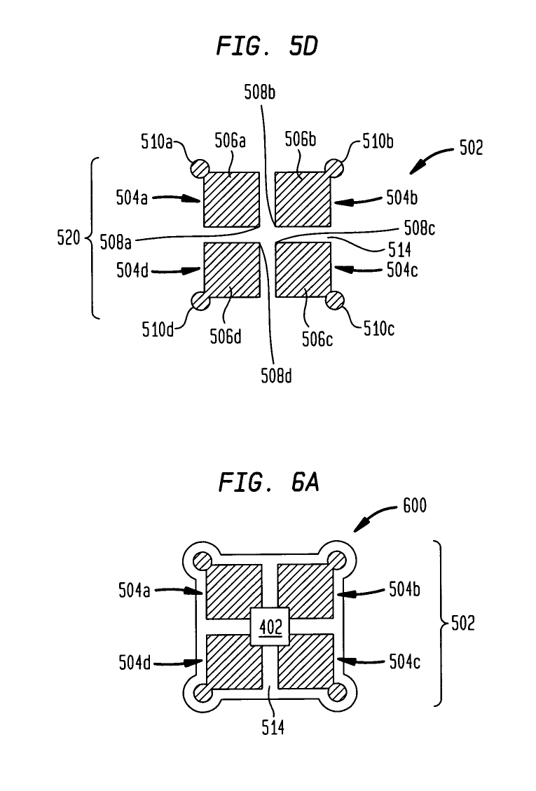

FIG. 5A shows characteristic impedance equivalent circuit 410 for chip 402 and a characteristic impedance equivalent circuit 540 for a quadraposer substrate 502 that together form a quadraposer, according to an example embodiment of the present invention. When combined to form a quadraposer, chip 402 mounts to quadraposer substrate 502, such that ports 430 and 432 of chip 402 are coupled to first and second mounting pads 530 and 532 of quadraposer substrate 502. When the quadraposer is integrated with an item, first and second interface pads 534 and 536 of quadraposer substrate 502 are coupled to coupling points (e.g., coupling points 434 and 436 shown in FIG. 4A) of the item.

Characteristic impedance equivalent circuit 540 of quadraposer substrate 502 includes an equivalent resistance 542, equivalent capacitance 544, and equivalent inductance 546, coupled in parallel (which could alternatively be represented as coupled in series). Similarly to the description provided above regarding the need for matching an impedance of chip 402 to an impedance of a material of item 400, a combined impedance of chip 402 and quadraposer substrate 400 (including any adhesives, etc) is matched with an impedance of item 400. Thus, the impedance of circuit 410 or die 402 and of circuit 540 of quadraposer substrate 502 can be combined, to determine a match to the impedance of item 400. In embodiments, a matching network can be used with die 402, quadraposer substrate 502, and/or item 400, to provide an impedance match for any impedance mismatch.

FIGS. 5B and 5C show example matching networks that match an impedance of chip 402 and quadraposer substrate 502 of FIG. 5A with an item, according to embodiments of the present invention. FIG. 5B shows a matching network 550 incorporated in chip 402, similarly to matching network 450 shown incorporated in chip 402 in FIG. 4B. Matching network 550 is used to tune a combined impedance of chip 402 and quadraposer substrate 502, as present at interface pads 534 and 536 of quadraposer substrate 502, to match an impedance of an item, such as item 400, at the mounting point of the item. Matching network 550 may be configured in any manner to provide a desired impedance, such as similarly to matching network 450 described above.

FIG. 5C shows a matching network 560 incorporated in quadraposer substrate 502. Matching network 560 is used to tune a combined impedance of chip 402 and quadraposer substrate 502, as present at interface pads 534 and 536, to match an impedance of an item, such as item 400, at the mounting point of the item. Matching network 560 may be a circuit board, a chip/die, or other device or medium coupled in/on item 400. Matching network 560 may be configured in any manner to provide a desired impedance, such as similarly to matching networks 550 (of FIG. 5B) and 460 (of FIG. 4C). For example, matching network 560 may include a bank of resistors, capacitors, and/or inductors mounted to quadraposer substrate 502. Matching network 560 may include one or more circuit traces formed on quadraposer substrate 502 having selected lengths, widths, and/or thicknesses, to provide a desired impedance. The traces may be trimmed (i.e., have metal removed), have slots formed therein, etc., to tune an impedance of matching network 560.

Note that in embodiments, a matching network for the configuration of FIGS. 5A-5C may also be present on item 400, similarly as shown in FIG. 4D. A matching network may be spread among chip 402, quadraposer substrate 502, and item 400, in any combination or manner.

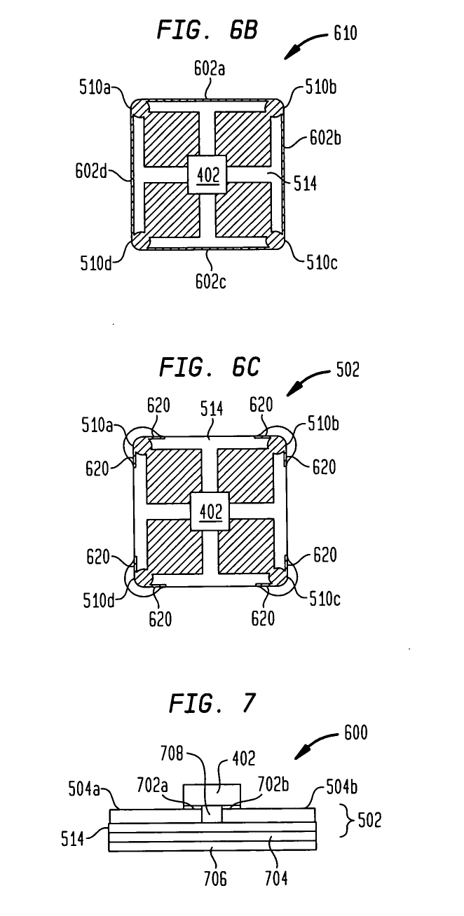

FIG. 5D shows a view of an intermediate substrate 502 having a conductive pattern 520. Conductive pattern 520 is used to electrically interface chip 420 with item 400. Furthermore, conductive pattern 520 is configured to provide an impedance match for item 400. In the example of FIG. 5D, conductive pattern 520 has four patterned conductive segments 504a-504d. Conductive pattern 520 may be formed in or on a non-electrically conductive substrate layer 514 of substrate 502, such as a paper layer, a plastic film, MYLAR®, a clothe-like material such as TYVEC®, etc. FIGS. 6A and 7 show views of chip 402 attached to substrate 502 to form a quadraposer 600, according to an embodiment of the present invention.

Chip 402 has four pads 702a-d (pads 702c and 702d are not shown in FIG. 7). Each of pads 702a-d are electrically coupled to a corresponding one of segments 504a-504d. In FIG. 5D, segments 504a-504d are each shown as having one of rectangular portions 506a-506d, respectively. Rectangular portions 506a-506d are electrically isolated from each other (although in some embodiments, one or more of them may be coupled together), and are arranged to form a larger rectangular shape. An inner corner 508a-508d of each of rectangular portions 506a-506d provides a respective landing area for one of pads 702a-d of chip 402.

Each of segments 504a-504d has a respective pad 510a-510d connected to an outer corner 512a-512d of each of rectangular portions 506a-506d. When quadraposer 600 is attached to item 400, rectangular portions 506a-506d may be electrically isolated from item 400 (e.g., by substrate layer 514, which may be present between rectangular portions 506a-506d and item 400, as shown in FIG. 7) while pads 510a-510d are electrically coupled to item 400, such as at landing pads 404a-404d of item 400 (when present). For example, in an embodiment, substrate layer 514 is not present between pads 510a-510d and item 400. Thus, segments 504a-504d provide electrical connections between chip 402 and item 400. As further described below, quadraposer 600 can be attached to item 400 in an inverted or non-inverted orientation.

Segments 504a-504d are typically made from an electrically conductive material, including a metal (such as aluminum, copper, gold, silver, etc), a combination of metals/alloy, a conductive (e.g., metal) foil, a metallic film, a conductive ink (e.g., a silver ink), etc. Note that segments 504a-504d may have shapes other than those shown in FIGS. 5 and 6, and fewer or greater numbers of segments 504 may be present for different antenna configurations. Any number of one of more segments 504 may be present, depending on the particular application.

Chip 402 may be attached to substrate 502 in a variety of ways, including by an adhesive material, such as a solder, an electrically conductive adhesive (e.g., isotropic or an anisotropic conductive adhesive, such as Z-axis conductive adhesive), ultrasound, etc. Pads of chip 402 may also be capacitively coupled to item 400 or conductive pattern 520. Capacitive coupling-type attachment of pads of chip 402 to segments 504 eliminates the need for conductive adhesives between the pads of chip 402 and landing areas of segments 504. As shown in FIG. 7, quadraposer 600 may include an adhesive material layer 704. Adhesive material layer 704 may be used to adhere quadraposer 600 to a surface of an item/object. Adhesive material layer 704 may include any type of adhesive, including a pressure sensitive adhesive material, cold temp adhesives, pharmaceutical adhesives, freezer adhesive, removable adhesives, high-tech adhesives (e.g., for sticking to tires), an epoxy, a solder layer, and other adhesive material types. In an embodiment, a release liner 706 may be present on the bottom surface of adhesive material layer 704. Release liner 706 may be removed to expose adhesive material layer 704 for attaching quadraposer 600 to item 400 by adhesive material layer 704.

In an embodiment, quadraposer substrate 502 is formed in a way to prevent electrostatic discharge (ESD) damage to die 402. For example, FIG>6B shows an initial quadraposer substrate 610 having four electrical connectors 602a-602d that each short a pair of pads 510a-510d together. In this manner, pads of die 402 are shorted together when mounted to quadraposer substrate 610, thus reducing a risk of ESD damage to die 402 during handling.

Electrical connectors 602a-602d can be removed prior to attaching the quadraposer to an item. For example, as shown in FIG. 6C, electrical connectors 602a-602d can be removed when cutting quadraposer substrate 610 (such as from a larger substrate) to form quadraposer substrate 502. As shown in FIG. 6C, each of electrical connectors 602a-602d have been separated, and no longer short adjacent pads 510a-510d. In an embodiment, as shown in FIG. 6C, connector segments 620 can be left remaining on quadraposer substrate 502 after cutting quadraposer substrate 610 to form quadraposer substrate 502. For example, connector segments 620 can be intentionally shaped to tune an impedance of quadraposer 600, for matching with and impedance of item 400.

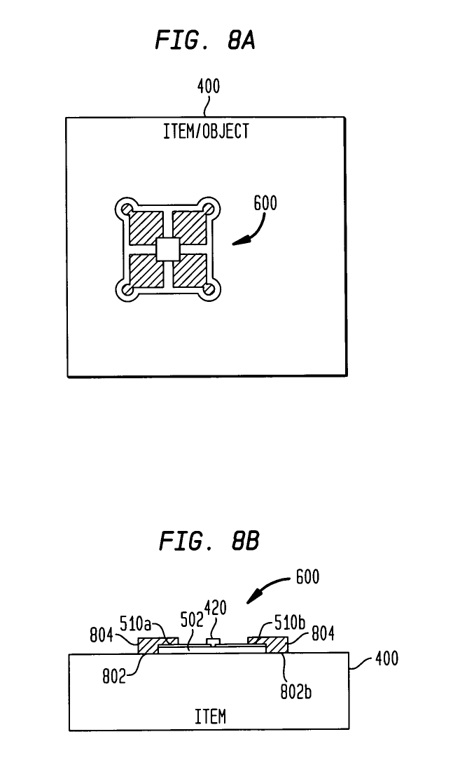

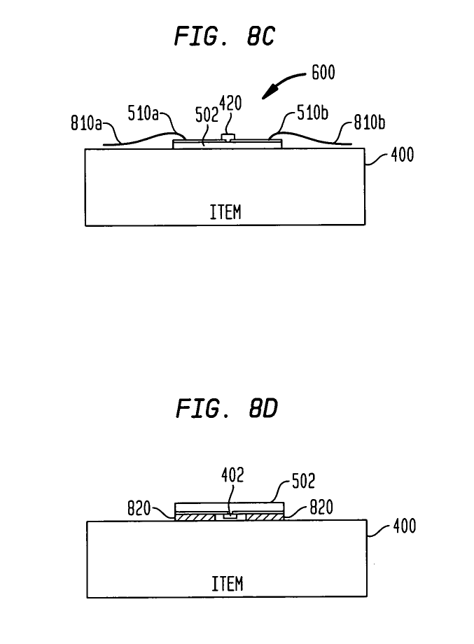

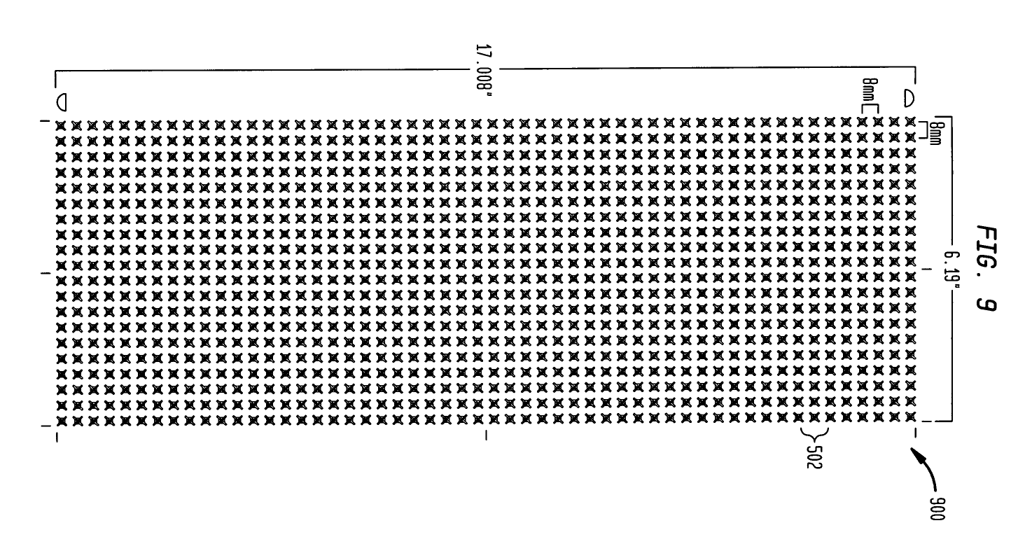

Quadraposer 600 may be integrated with item 400 to incorporate RFID tag functionality into item 400, such as shown in FIG. 8A. For example, substrate 502 of quadraposer 600 may be attached to item 400 in a variety of ways, including by solder, an adhesive material, such as an electrically conductive adhesive (including an anisotropic adhesive), etc. In the example of FIG. 8A, quadraposer 600 is attached to item 400 by adhesive material layer 704 of quadraposer 600. For instance, a peel-away release liner 706 may be peeled from quadraposer 600 to expose adhesive material layer 704. Then, quadraposer 600 can be applied to item 400 for attachment. Such application of quadraposer 600 to item 400 may be performed by hand or by semi- or fully automated mechanism. In either case, the quadraposer pads are aligned over the bonding pads of the item, and the two are brought in physical contact to make the connection.

As described above, quadraposer 600 can be mounted to item 400 in an inverted or non-inverted manner (such as in FIG. 8A). For example, FIG. 8B shows quadraposer 600 mounted to item 400 in a non-inverted manner, such that quadraposer substrate 502 is between chip 402 and item 400. When mounted in this manner, pads 510 of quadraposer 600 can be coupled to item 400 in a variety of ways. For example, FIG. 8B shows a conductive adhesive 804, such as a solder, silver-filled epoxy, etc., that couples pads 510a and 510b to coupling points 802a and 802b, respectively, of item 400.

In another embodiment, FIG. 8C shows first and second conductive threads 810a and 810b that couple pads 510a and 510b, respectively, to item 400. For example, conductive threads 810a and 810b may be made from an electrically conductive material, such as metal (e.g., aluminum, copper, gold, silver, etc). Conductive threads 810a and 810b may be connected to pads 510a and 510b, and to item 400, using a wire bond attachment mechanism (such as used in area grid array integrated circuit packages). Alternatively, conductive threads 810a and 810b may be connected to pads 510a and 510b, and to item 400, using a sewing machine apparatus, which sews threads 810a and 810b into quadraposer substrate 502 (which may be made of a cloth-like material), and into item 400. In an embodiment, threads 810a and/or 810boperate as an antenna for quadraposer 600. In such an embodiment, a length of threads 810 can be selected to be a desired wavelength, or fraction of a wavelength (e.g., ¼ wavelength), of a frequency to be transmitted by the RFID enabled item. Thus, threads 810 could act as dipole antennas.

FIG. 8D shows quadraposer 600 mounted to item 400 in an inverted manner, such that chip 402 is between quadraposer substrate 502 and item 400. In such an embodiment, chip 402 may alternatively be mounted in a recessed area of quadraposer substrate 502. As shown in FIG. 8D, pads 510 of quadraposer 600 can be coupled to item 400 in a variety of ways. For example, FIG. 8D shows a conductive adhesive 820, such as a solder, silver-filled epoxy, etc., that couples pads 510a and 510b of quadraposer 600 to coupling points of item 400.

Quadraposers 600 may be manufactured in high volume, such as by ways described elsewhere herein. For example, FIG. 9 shows a web 900 containing a plurality of substrates 502 that can be used to manufacture a respective plurality of quadraposers 600. During an assembly process, a chip 402 may be attached to each of substrates 502. The resulting quadraposers 600 may be tested in web 900, or after separation from web 900. A protective layer, such as a layer of plastic or an encapsulating material, may be applied to environmentally protect chips 402 on substrates 502. The resulting quadraposers 600 may be separated from web 900 for application to items/objects.

Quadraposers 600 may have sizes and proportions defined as required by a particular application. For example a center-to-center pitch for adjacent substrates 502 in FIG. 9 may be 8 mm, and thus substrates 502 in FIG. 9 may have width and length dimensions of approximately 5-6 mm, for instance. These dimensions are provided for illustrative purposes, and are not limiting, however.

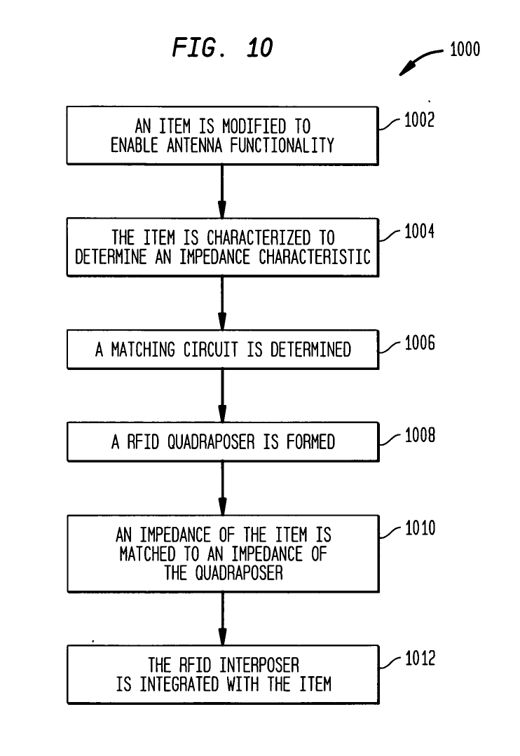

FIG. 10 shows a flowchart 1000 providing steps for forming an RFID tag enabled item, according to an example embodiment of the present invention. Other structural and operational embodiments will be apparent to persons skilled in the relevant art(s) based on the following discussion. Not all of the steps of flowchart 1000 are required for all embodiments, as will be apparent from the description herein. Furthermore, the steps of flowchart 1000 do not necessarily have to occur in the order shown.

Flowchart 1000 begins in step 1002. Step 1002 is optional. In step 1002, an item is modified to enable antenna functionality. For example, if the item is intended to operate as a slot antenna, a slot may be formed in the item. If the item is intended to operate as a patch antenna, an area of a patch for a patch antenna may be sized. If the item is lacking a conductive material, a conductive material may be incorporated, including a metal sheet, a metal thread, etc. If the item includes conductive element that is too large, or otherwise undesirable, the element may have cuts/slits formed therein to isolate a smaller conductive area for attachment of the RFID die or quadraposer.

Furthermore, step 1002 may include the incorporation of coupling points in/on the item for attaching a die or quadraposer.

In step 1004, the item is characterized to determine an impedance characteristic. For example, known techniques can be used to analyze RF properties of items to determine an impedance characteristic of the object. For instance, spectrum analyzers and/or logic analyzers may be used. In an embodiment, a material of the object is characterized. For instance, a metal, metal foil, metallic, film, ink, of other chemistry of an object material may be characterized. Further examples of the characterization of items are described below, with respect to example embodiments of the present invention.

In step 1006, a matching circuit is determined. The matching circuit may be determined from a measured or known initial impedance of a prospective quadraposer (e.g., see below), and the determined impedance characteristic of the item. The matching circuit may be determined by modeling/simulating on a computer, by viewing a Smith chart, etc.

In step 1008, a RFID quadraposer is formed. For instance, in an embodiment, a RFID quadraposer is formed in a manner to match the determined characteristic of the object. Thus, referring to substrate 502 of FIG. 5, for example, conductive pattern 520, including one or more of segments 504, can be shaped, sized, and formed from a selected material to match the impedance characteristic. Shaping a segment 504 may include selecting a shape, such as a rectangle, circle, other polygon, or irregular shape for the segment, forming one or more holes and/or slots in the segment, etc. Sizing a segment 504 may include adjusting an area (i.e., length and/or width) and/or thickness of the segment. Conductive pattern 520 may be formed from various materials, including a selected metal, alloy, etc., to aid in matching the determined impedance characteristic. Also, capacitors, inductors, and/or resistors may be incorporated on the quadraposer.

In step 1010, an impedance of the item is matched to an impedance of the quadraposer. For example, the determined matching circuit is used to provide the impedance match. The matching circuit may be incorporated in the RFID chip, the quadraposer substrate, the item, any combination of the same, etc.

In an embodiment, an initial impedance of chip 402 or quadraposer 600 is known. For example, these impedances may be controlled and maintained during manufacturing of chip 402 or quadraposer 600. The manufacturing process itself may be accurate enough to maintain the impedance of chip 402 or quadraposer 600 within an acceptable range, or the impedance may be tuned after manufacture. Known tuning techniques may be used, including trimming techniques.

In step 1012, the RFID quadraposer is integrated with the item. For example, as described above, and shown in FIGS. 4 and 8, a formed quadraposer 600 can be integrated with item 400, such as by being attached to the object, inserted in the object, having the object formed around the quadraposer, or being attached to a packaging material for the object in such a way as to align and bring into contact the bonding pads of the quadraposer to the bonding pads of the item. Further examples of quadraposers 600 related to various example items 400 are described below.

Smart RFID Cigarette Pack Embodiments

An example of item 400 is a cigarette pack or carton. As described above, what is needed is a cigarette pack that can be automatically and remotely identified for inventory purposes and/or for purchasing (such as in a check out line). In an embodiment, an RFID cigarette pack uses the foil sheet of a conventional cigarette pack as an antenna for the RFID cigarette pack. Thus, in step 1002 of FIG. 10, the foil sheet may be characterized to determine an impedance characteristic. In step 1004, a quadraposer may be formed to match the determined impedance characteristic of the foil sheet.

Furthermore, optionally, the foil sheet of the cigarette pack may be modified to provide bonding pads to match to the quadraposer.

In embodiments, an integrated circuit (IC) die, and optionally further circuitry, is attached to the conventional foil sheet of a cigarette pack. The IC die interfaces with the foil sheet as an antenna, using the foil sheet to receive signals for the IC die, and transmit signals from the IC die, as an antenna. In an embodiment, the IC die is attached directly to the foil sheet, or to coupling structures formed on the foil sheet.

In another embodiment, a “quadraposer” that mounts the die is attached to the conventional foil layer of the cigarette pack to create the RFID cigarette pack.

For example, the foil layer may be a 4″×4″ aluminum rectangle. FIG. 11 shows an example exploded diagram of the internal components of a RFID cigarette pack 100.

FIG. 11 shows an example RFID enabled cigarette pack portion 1100 that can be inserted in a cigarette pack to create a RFID enabled cigarette pack, As shown in FIG. 11, a quadraposer layer or substrate 1104 mounts an IC die 1102. In an embodiment, substrate 1104 includes a matching network, for matching die 1102 with a foil layer 1106. Substrate 1104 has an adhesive layer 1110 on a bottom surface, for attaching to foil layer 1106. Die 1102, substrate 1104, and adhesive layer 1110 form a quadraposer 1112 for attachment to foil layer 1106.

In an embodiment, the RFID cigarette pack may also include a paper layer 1108, which is typically present in conventional cigarette packs. For example, foil layer 1106 and paper layer 1108 wrap around cigarettes (not shown) in the RFID cigarette pack.

In embodiments, substrate 1104 has a conductive pattern (e.g., conductive pattern 520) of one or more segments which couple with one or more pads of IC die 1102. For example, the formed RFID cigarette pack may include one or more antennas formed by foil layer 1106. In a single antenna embodiment, IC die 1102 has a radio frequency (RF) pad and a ground/return pad. In embodiments with additional antennas, IC die 1102 may have more sets of these pads. Substrate 1104 and IC die 1102 can have any arrangement and number of lands (when present) and pins, depending on the particular application.

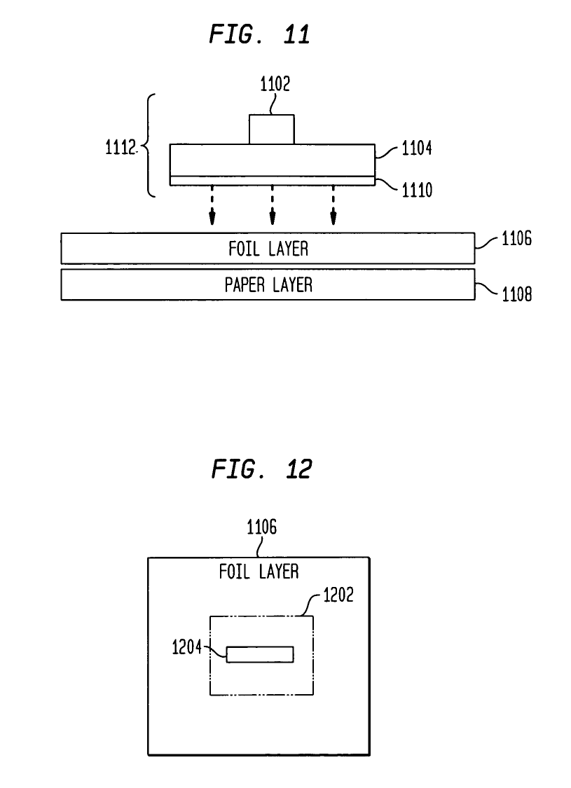

By attaching substrate 1104 to foil layer 106, IC die 1102 is electrically coupled to foil layer 1106 through a matching network (when present) of substrate 1104. FIG. 12 shows a plan view of foil layer 1106, and indicates an example position 1202 for attachment of substrate 1104 (dotted line indicates an outline of an attached substrate 1104).

As shown in the embodiment of FIG. 12, foil layer 1106 has a centrally located slot 1204 formed therein. Slot 1204 (when present) is positioned in foil layer 1106 to aid in making foil layer 1106 resonant at a desired frequency, and can be adjusted in size (e.g., length, width, shape, etc.) (e.g., in step 1004 of FIG. 10) to adjust the resonant frequency of foil layer 1106 to allow foil layer 1106 to operate as an antenna in a desired frequency range. Thus, foil layer 1106, with quadraposer 1112, is configured to operate as an antenna, such as a slot antenna, as would be understood by persons skilled in the relevant art(s). Alternatively, foil layer 1106, with quadraposer 1112, may be configured to operate as a patch antenna, or other antenna type.

In completing formation of the RFID cigarette pack, foil layer 1106, substrate 1104, and paper layer 1108 may be folded as needed to fit in an RFID cigarette pack adjacent to or around any enclosed cigarettes.

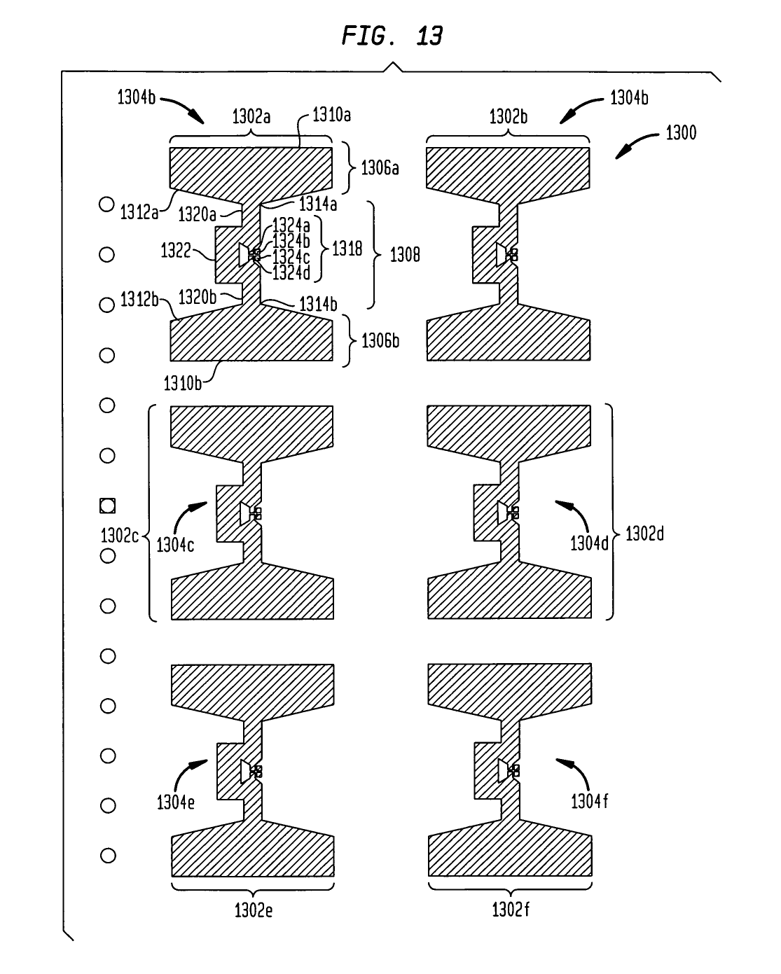

As described above, a conductive pattern may have a variety of configurations. For example, FIG. 13 shows a portion of a web 1300 of example quadraposer substrates 1302a-1302f, according to an embodiment of the present invention. Each of quadraposer substrates 1302a-1302f has one of conductive patterns 1304a-1304f.

Each conductive pattern 1304 is shaped similarly to a capital letter “I.” Each conductive pattern 1304 includes a first pad 1306a, a second pad 1306b, and a bridge portion 1308. First and second pads 1306a and 1306b form upper and lower horizontal portions of the “I” shape, and are coupled together by bridge portion 1308, which forms the central vertical portion of the “I” shape.

First pad 1306a has a straight outer edge 1310a and an inner edge 1312a opposed to outer edge 1310a. Inner edge 1312a tapers (e.g., in a linear convex manner) toward a central location of inner edge 1312a that is coupled to an first end 1314a of bridge portion 1308. In a similar, vertically flipped, manner, second pad 1306b has a straight outer edge 1310b and an inner edge 1312b opposed to outer edge 1310b. Inner edge 1312b tapers (e.g., in a linear convex manner) toward a central location that is coupled to a second end 1314b of bridge portion 1308.

Bridge portion 1308 includes a die mount location 1318 located centrally along a vertical elongated portion 1320 of bridge portion 1308 between first and second ends 1314a and 1314b. Die mount location 1318 separates vertical elongated portion 1320 into upper and lower half portions 1320a and 1320b. Bridge portion 1310 further includes a letter “c” shaped portion 1322 having first and second ends coupled to respectively to portions 1320a and 1320b to bypass die mount position 1318. Die mount location 1318 includes four lands 1324a-1324d for coupling with four pads of a die/chip that mounts to die mount location 1318. Lands 1324a-1324d are arranged a square pattern, in a clockwise fashion. Land 1324a is located in an upper left corner of the square pattern, and is connected to an end of upper half portion 1320a. Land 1324b is coupled to lower half portion 1320b by a thin strip positioned to bypass land 1324c. Land 1324c is electrically isolated. Land 1324d is coupled to an end of lower half portion 1320b.

Quadraposer substrates 1302a-1302f can have a variety of sizes. For example, substrate 1302a may be 2.4 inches by 2.0 inches in size, or other size configured to attach to and match an impedance of a foil layer.

Each of quadraposer substrates 1302a-1302f can have a die, such as die 1102 of FIG. 11, mounted to die mount location 1318 to form six quadraposers. The quadraposers can be separated from web 1300, and attached to foil layers of cigarette packs, to form smart RFID cigarette packs. In a similar fashion, other items/objects having foil layers as part of the items/objects (including their packaging), can be converted to smart RFID items by introducing quadraposers formed in a similar manner.

Further Example Smart RFID Consumer Product Packaging Embodiments

As described above, a wide variety of consumer product packaging may be RFID enabled, according to embodiments of the present invention. Such packaging includes wine bottles and bottles containing other liquids, food cans and cans storing other materials, vitamin and medicine containers, and packaging for optical storage media (e.g., compact discs, digital video discs), toys, appliances, cosmetics, etc.

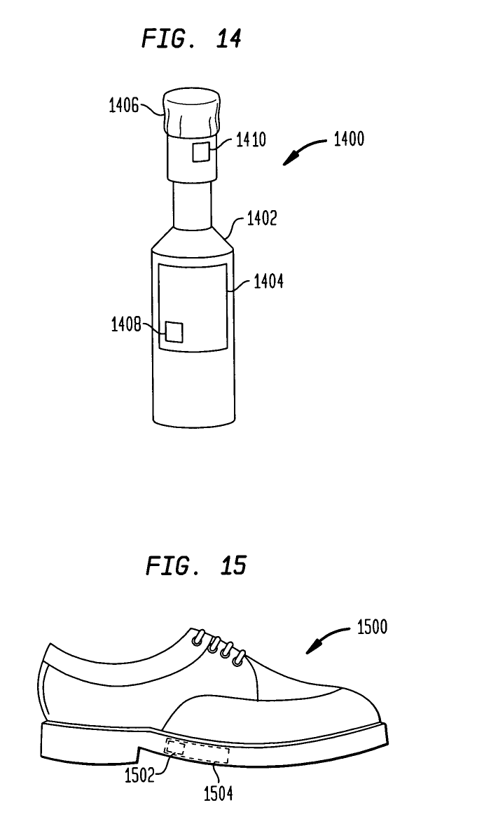

For example, FIG. 14 shows an RFID enabled wine bottle 1400, according to an example embodiment of the present invention. As shown in FIG. 14, wine bottle 1400 includes a base bottle 1402, a label 1404, and a sealing foil 1406. In an embodiment, label 1404 has a first RFID enabling circuit 1408 incorporated therewith. RFID enabling circuit 1408 includes an RFID die or chip, such as chip 402, which provides RFID functionality to wine bottle 1400. The chip of RFID enabling circuit 1408 may be attached directly to label 1404, in a similar manner as described above with respect to FIG. 4, or RFID enabling circuit 1408 may include a quadraposer substrate, similar to substrate 502 of quadraposer 600 of FIG. 6, to interface the chip with label 1404.

In an embodiment, a radio frequency property of the material of label 1404 and/or of bottle 1402 is characterized to determine an impedance characteristic (e.g., according to step 1002 of FIG. 10). RFID enabling circuit 1408 is formed to match the impedance characteristic (e.g., according to step 1004 of FIG. 10). Thus, for example, if RFID enabling circuit 1408 is a quadraposer including conductive segments, such as shown in FIG. 6, one or more of the segments can be shaped, sized, and formed from a selected material to match the impedance characteristic. RFID enabling circuit 1408 can be integrated with wine bottle 1400 (e.g., according to step 1006 of FIG. 10) in various ways, including being integrated in label 1404 during conventional assembly of wine bottle 1400, or by being attached to label 1404 after assembly of wine bottle 1400.

In an embodiment, label 1404 is modified (at any point during manufacture of wine bottle 1400) to enable antenna functionality. For example, a slot may be formed in label 1404 to configure label 1404 as a slot antenna. Furthermore, in an embodiment, coupling pads are formed on label 1404 for mounting a die or quadraposer.

In another embodiment, wine bottle 1400 alternatively (or additionally) includes a second RFID enabling circuit 1410 that is incorporated with sealing foil 1406. In a like manner to first RFID enabling circuit 1408, second RFID enabling circuit 1410 includes a chip (in or not in quadraposer form) that provides RFID functionality to wine bottle 1400.

In an embodiment, a radio frequency property of the material of sealing foil 1406 is characterized to determine an impedance characteristic, and RFID enabling circuit 1410 is formed to match the impedance characteristic. RFID enabling circuit 1410 can then be integrated with wine bottle 1400, such as being formed in or attached to sealing foil 1406 at any point during or after the manufacturing process for wine bottle 1400. A wire cap frequently used on Champaign or wine bottles may be used as an antenna, in a similar fashion.

In an embodiment, sealing foil 1406 is modified to enable antenna functionality. For example, a slot may be formed in sealing foil 1406 to configure sealing foil 1406 as a slot antenna. Furthermore, in an embodiment, coupling pads are formed on sealing foil 1406 for mounting a die or quadraposer.

In a similar manner to wine bottle 1400, other consumer product packaging can be provided with RFID tag functionality by including an RFID enabling circuit that is matched with an impedance characteristic of the consumer product packaging. If needed, the product packaging can be modified (during manufacture) to provide antenna functionality (e.g., incorporating a slot, sizing an area of a patch for a patch antenna, incorporating a metal thread, etc), and/or coupling points can be added for a quadraposer. For example, the material of anti-tamper and freshness foils of medicines, foods, vitamins, may be matched by an RFID enabling circuit. Any metallic foils or films in consumer product packaging for toys, appliances, cosmetics, etc., can be matched by an RFID enabling circuit. Further consumer product packing known to persons skilled in the relevant art(s) may also be matched, to provide RFID functionality, according to embodiments of the present invention.

Example Smart RFID Consumer Goods Embodiments

As described above, a wide variety of consumer goods may be RFID enabled, according to embodiments of the present invention. Such consumer goods include shoes and other clothing, credit cards, and handheld electronic devices, such as handheld computers, MP3 players, and cell phones.

For example, FIG. 15 shows a RFID enabled shoe 1500, according to an example embodiment of the present invention. As shown in FIG. 15, shoe 1500 includes a RFID enabling circuit 1502. In the example of FIG. 15, RFID enabling circuit 1502 is coupled to a metal support 1504 of shoe 1500. In alternative embodiments, RFID enabling circuit 1502 may be mounted in or coupled to other elements of shoe 1500, including a heal, sole, etc., of shoe 1500. If needed, the shoe element can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

RFID enabling circuit 1502 includes an RFID die or chip, such as chip 402, which provides RFID functionality to shoe 1500. The chip of RFID enabling circuit 1502 may be attached directly to metal support 1504, similarly to as described above with respect to FIG. 4, or RFID enabling circuit 1502 may include a quadraposer substrate, similar to substrate 502 of quadraposer 600 of FIG. 6, to interface the chip with label 1504.

In an embodiment, a radio frequency property of the material of metal support 1504 and/or shoe 1500 is characterized to determine an impedance characteristic, and RFID enabling circuit 1502 is formed to match the impedance characteristic. RFID enabling circuit 1502 can then be integrated with shoe 1500 at any point during or after the manufacturing process for shoe 1500.

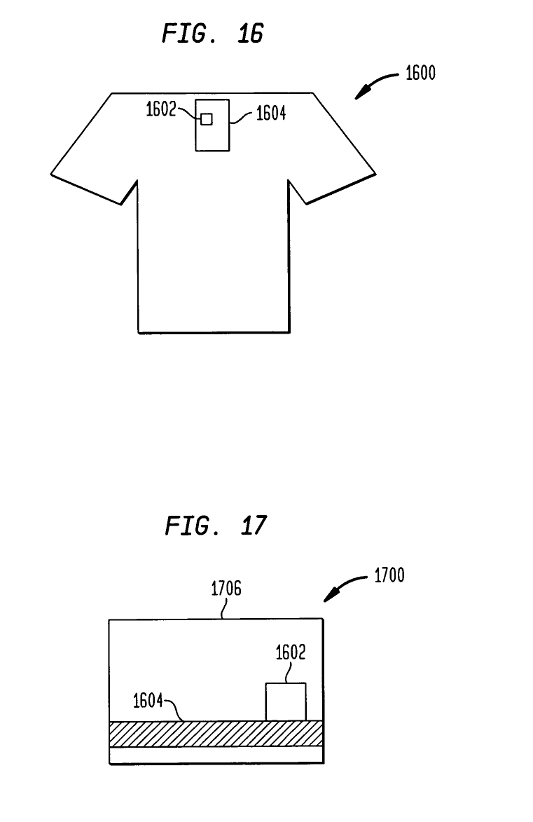

In another example, FIG. 16 shows a RFID enabled shirt 1600, according to an example embodiment of the present invention. As shown in FIG. 16, shirt 1600 includes a RFID enabling circuit 1602. In the example of FIG. 16, RFID enabling circuit 1602 is coupled to a care tag 1604 of shirt 1600. For example, care tag 1604 may be frequently found hanging from a rear collar area of shirt 1600 (as shown in FIG. 16) or hanging from a seam of shirt 1600. In alternative embodiments, RFID enabling circuit 1602 may be mounted in or coupled to other elements of shirt 1600, including in a seam, between layers of fabric, etc., of shirt 1600. In a similar manner, RFID enabling circuit 1602 can be integrated with other types of clothing to create smart RFID clothing, including pants, socks, a belt, a jacket, underwear, a hat, gloves, etc. If needed, the clothing can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

RFID enabling circuit 1602 includes an RFID die or chip, such as chip 402, which provides RFID functionality to shirt 1600. The chip of RFID enabling circuit 1602 may be attached directly to care tag 1604, such as described above with respect to FIG. 4, or RFID enabling circuit 1602 may include a quadraposer substrate, similar to substrate 502 of quadraposer 600 of FIG. 6, to interface the chip with care tag 1604.

In an embodiment, a radio frequency property of the material of care tag 1604 and/or shirt 1600 is characterized to determine an impedance characteristic, and RFID enabling circuit 1602 is formed to match the impedance characteristic For example, care tag 1604 may include metallic fibers or other material that can be characterized. RFID enabling circuit 1602 can then be integrated with shirt 1600 at any point during or after the manufacturing process for shirt 1600.

In another example, FIG. 17 shows a RFID enabled debit or credit (or other type) card 1700, according to an example embodiment of the present invention. As shown in FIG. 17, credit card 1700 includes a RFID enabling circuit 1702. In the example of FIG. 17, RFID enabling circuit 1702 is mounted in or on a plastic substrate 1706 of credit card 1700, and is coupled to a magnetic strip 1704 of credit card 1700. In alternative embodiments, RFID enabling circuit 1702 may be mounted in or coupled to other elements of credit card 1700.

RFID enabling circuit 1702 includes an RFID die or chip, such as chip 402, which provides RFID functionality to credit card 1700. The chip of RFID enabling circuit 1702 may be attached directly to magnetic strip 1704, such as described above with respect to FIG. 4, or RFID enabling circuit 1702 may include a quadraposer substrate, similar to substrate 502 of quadraposer 600 of FIG. 6, to interface the chip with magnetic strip 1704.

In an embodiment, a radio frequency property of the material of magnetic strip 1704 and/or credit card 1700 is characterized to determine an impedance characteristic, and RFID enabling circuit 1702 is formed to match the impedance charcteristic. RFID enabling circuit 1702 can then be integrated with credit card 1700 at any point during or after the manufacturing process for credit card 1700. If needed, the credit card can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer (e.g., to be coupled to magnetic strip 1704).

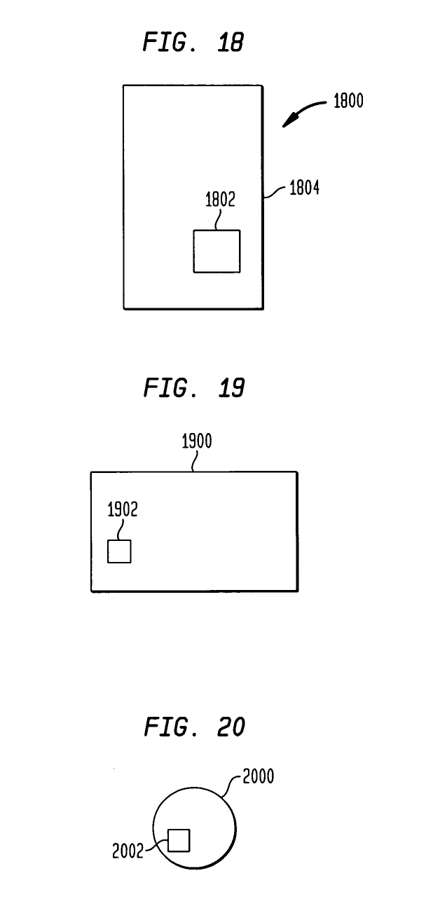

In another example, FIG. 18 shows a RFID enabled mobile device 1800, according to an example embodiment of the present invention. As shown in FIG. 18, mobile device 1800 includes a RFID enabling circuit 1802. In the example of FIG. 18, RFID enabling circuit 1802 is coupled to an inner or outer surface of a casing 1804 of mobile device 1800. In alternative embodiments, RFID enabling circuit 1802 may be mounted to a component inside mobile device 1800, including a circuit board, an antenna, etc., of mobile device 1800. In embodiments, mobile device 1800 may be any type of mobile device. For example, mobile device 1800 may be a hand held computer, such as a BLACKBERRY™ device, a personal digital assistant (PDA), a PALM PILOT™, a laptop computer, or other type of mobile computing device. Alternatively, mobile device 1800 can be an MP3 player, such as an APPLE IPOD™ device, a cell phone, or other type of mobile electronics device.

RFID enabling circuit 1802 includes an RFID die or chip, such as chip 402, which provides RFID functionality to mobile device 1800. The chip of RFID enabling circuit 1802 may be attached directly to casing 1804, such as described above with respect to FIG. 4, or RFID enabling circuit 1802 may include a quadraposer substrate, similar to substrate 502 of quadraposer 600 of FIG. 6, to interface the chip with casing 1804.

In an embodiment, a radio frequency property of the material of casing 1804 and/or other portions of mobile device 1800 is characterized to determine an impedance characteristic, and RFID enabling circuit 1802 is formed to match the impedance characteristic. For example, casing 1804 may include a metal, alloy, or other material that can be characterized. Alternatively, other portions of mobile device 1800 coupled to RFID enabling circuit 1802 may be characterized, such as a circuit board, antenna, etc., to match the impedance characteristic. RFID enabling circuit 1802 can then be integrated with mobile device 1800 at any point during or after the manufacturing process for mobile device 1800.

If needed, casing 1804 or other material of mobile device 1800 can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

In another example, coins and currency may be converted into smart RFID items, according to embodiments of the present invention. For example, FIG. 19 shows a RFID enabled bill 1800, and FIG. 20 shows an RFID enabled coin 2000, according to example embodiments of the present invention. As shown in FIG. 19, bill 1900 includes a RFID enabling circuit 1902. RFID enabling circuit 1902 may be attached to, or incorporated in bill 1900. As shown in FIG. 20, coin 2000 includes a RFID enabling circuit 2002. RFID enabling circuit 2002 may be attached to, or incorporated in coin 2000.

RFID enabling circuits 1902 and 2002 each includes an RFID die or chip, such as chip 402, which provides RFID functionality to bill 1900 and coin 2000, respectively. The chips of RFID enabling circuits 1902 and 2002 may be respectively attached directly to bill 1900 and coin 2000, such as described above with respect to FIG. 4, or RFID enabling circuits 1902 and 2002 may include a quadraposer substrate, similar to substrate 502 of quadraposer 600 of FIG. 6, to interface the chips with bill 1900 and coin 2000.

In an embodiment, radio frequency properties of the material of bill 1900 and coin 2000 are each characterized to determine an impedance characteristic, and RFID enabling circuits 1902 and 2002 are respectively formed to match the corresponding impedance characteristic. If needed, the material of bill 1900 or coin 2000 can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer. For example, bill 1900 may include metallic fibers, security foils, or other materials that can be characterized. RFID enabling circuits 1902 and 2002 can then be respectively integrated with bill 1900 and coin 2000 at any point during or after the manufacturing processes for bill 1900 and coin 2000.

Example Smart RFID Building Structure Embodiments and Related Item Embodiments

As described above, a wide variety of building structures and related items may be RFID enabled, according to embodiments of the present invention. Such building structures include houses, office buildings, warehouses, factories, retail buildings, etc. Such related items include street and highway signs, doors and doorways, locking mechanisms, light fixtures, house wiring; flooring, windows and windshields, and statues. Further structures include cars and boats, and elements of the same including wheels and license plates, and also include bridges and elements of the same.

If needed, these structure, and those described as follows, can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

For example, FIG. 21 shows a smart RFID house 2100, having various RFID enabled elements. For example, house 2100 includes a RFID enabled doorway 2126, according to an example embodiment of the present invention. As shown in FIG. 21, doorway 2126 includes a RFID enabling circuit 2102. In the example of FIG. 21, RFID enabling circuit 2102 is coupled to a door 2104 of doorway 2126, such as at a doorknob, handle, kick plate, knocker, locking mechanism, or on the base structure of door 2104. In alternative embodiments, RFID enabling circuit 2102 may be mounted in or coupled to other elements of doorway 2126, including the door frame, a door bell, etc., of doorway 2126.

RFID enabling circuit 2102 includes an RFID die or chip, such as chip 402, which provides RFID functionality to doorway 2126. The chip of RFID enabling circuit 2102 may be attached directly to door 2104, such as described above with respect to FIG. 4, or RFID enabling circuit 2102 may include a quadraposer substrate, similar to substrate 502 of quadraposer 600 of FIG. 6, to interface the chip with door 2104.

In an embodiment, a radio frequency property of the material of door 2104 and/or of other portions of doorway 2126 is characterized to determine an impedance characteristic, and RFID enabling circuit 2102 is formed to match the impedance characteristic. For example, door 2104 (including a doorknob, handle, kick plate, knocker, locking mechanism, or base door structure) may include a metal or other material that can be characterized. RFID enabling circuit 2102 can then be integrated with doorway 2126 at any point during or after the manufacturing process for doorway 2126.

In a similar manner, RFID enabling circuit 2102 can be integrated with other elements of smart RFID house 2100. For example, house 2100 further includes a light fixture 2106, a support beam 2108, a window 2110, a wiring outlet 2112, and a floor 2114. RFID enabling circuit 2102 can be integrated with these elements and others of smart RFID house 2100.

Light FIG. 2106 includes a RFID enabling circuit 2116. RFID enabling circuit 2116 can be coupled to various areas of light fixture 2106, including a socket, light bulb, housing, etc. RFID enabling circuit 2116 may be in a chip-only or quadraposer configuration, as described above, for example. In an embodiment, a radio frequency property of a material of light fixture 2106, such as a socket, light bulb, housing, etc., can be characterized to determine an impedance characteristic to be matched by RFID enabling circuit 2116.

Support beam 2108 includes a RFID enabling circuit 2118. RFID enabling circuit 2118 can be coupled to various locations of support beam 2108. RFID enabling circuit 2118 may be in a chip-only or quadraposer configuration, for example, as described above. In an embodiment, a radio frequency property of a material of support beam 2108, such as a metal or alloy, etc., can be characterized to determine an impedance characteristic to be matched by RFID enabling circuit 2118. In a similar fashion, girders (e.g., steel girders) in buildings and bridges may be made into RFID enabled devices.

Window 2110 includes a RFID enabling circuit 2120. RFID enabling circuit 2120 can be coupled to various locations of window 2110. RFID enabling circuit 2120 may be in a chip-only or quadraposer configuration, as described above. In an embodiment, a radio frequency property of a material of window 2110, such as a glass pane (e.g., attaching a metallic sticker), a frame, windowsill, another metallic material of the window, etc., can be characterized to determine an impedance characteristic to be matched by RFID enabling circuit 2120. In a similar fashion, other types of windows may be made into RFID enabled devices by incorporation of RFID enabling circuit 2120, including windows and windshields of cars and other types of transportation devices.

Wiring outlet 2112 includes a RFID enabling circuit 2122. RFID enabling circuit 2122 can be coupled to various locations of wiring outlet 2112. RFID enabling circuit 2122 may be in a chip-only or quadraposer configuration, for example, as described above. In an embodiment, a radio frequency property of a material of wiring outlet 2112, such as a wire, an insulation material, a socket, an output panel, etc., can be characterized to determine an impedance characteristic to be matched by RFID enabling circuit 2122.

Floor 2114 includes a RFID enabling circuit 2124. RFID enabling circuit 2124 can be coupled to various locations of floor 2114. RFID enabling circuit 2124 may be in a chip-only or quadraposer configuration, for example, as described above. In an embodiment, a radio frequency property of a material of wiring outlet 2114, such as a tile or wooden panel, a flooring rebar, other metallic elements, etc., can be characterized to determine an impedance characteristic to be matched by RFID enabling circuit 2124.

A RFID enabling circuit can be integrated with light fixture 2106, support beam 2108, window 2110, wiring outlet 2112, and floor 2114 at any point during or after the respective manufacturing process.

In a similar manner to these elements of house 2100, other structural items can be provided with RFID tag functionality by including an RFID enabling circuit that is matched with an impedance characteristic of the structural item. For example, as shown in FIG. 21, a sign 2128 is located outside house 2100, and includes a RFID enabling circuit 2130. RFID enabling circuit 2130 can be coupled to various locations of sign 2128. RFID enabling circuit 2130 may be in a chip-only or quadraposer configuration, for example, as described above. In an embodiment, a radio frequency property of a material of sign 2128, such as a metal or alloy, etc., can be characterized to determine an impedance characteristic to be matched by RFID enabling circuit 2130. Sign 2128 may be any type of sign, including a street or highway sign. Furthermore, other similar structures, such as statues (e.g., metal statues), may be configured in a similar fashion to be a smart device. If needed, these further structural items can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

Example Optical Storage Medium Embodiments

Another example of item 400 is an optical storage medium, such as a compact disc (CD) (e.g., CDROM, CD-R, CD-RW, etc.) or a digital video disc (DVD) (e.g., DV-R, etc.). What is needed is an optical storage medium that can be automatically and remotely identified for inventory purposes and/or for purchasing (such as in a checkout line). In an embodiment, an RFID enabled optical storage medium uses the conventional disc metallization layer, which stores the data of the disc, as an antenna for the RFID enabled optical storage medium. Thus, in step 1002 of FIG. 10, the disc metallization layer may be characterized to determine an impedance characteristic. In step 1004, a quadraposer may be formed to match the determined impedance characteristic of the disc metallization layer.

In embodiments, an integrated circuit (IC) die, and optionally further circuitry, is attached to the conventional disc metallization layer of a optical storage medium. The IC die interfaces with the disc metallization layer as an antenna, using the disc metallization layer to receive signals for the IC die, and transmit signals from the IC die, as an antenna. In an embodiment, the IC die is attached directly to the disc metallization layer. In another embodiment, a quadraposer substrate is used to interface the IC die to the disc metallization layer, in quadraposer form.

If needed, the optical storage device can be modified (during manufacture) to provide antenna functionality (e.g., incorporating a slot for a slot antenna, sizing an area of a patch for a patch antenna, incorporating a metal thread for a dipole antenna, etc), and/or coupling points can be added for a die or quadraposer.

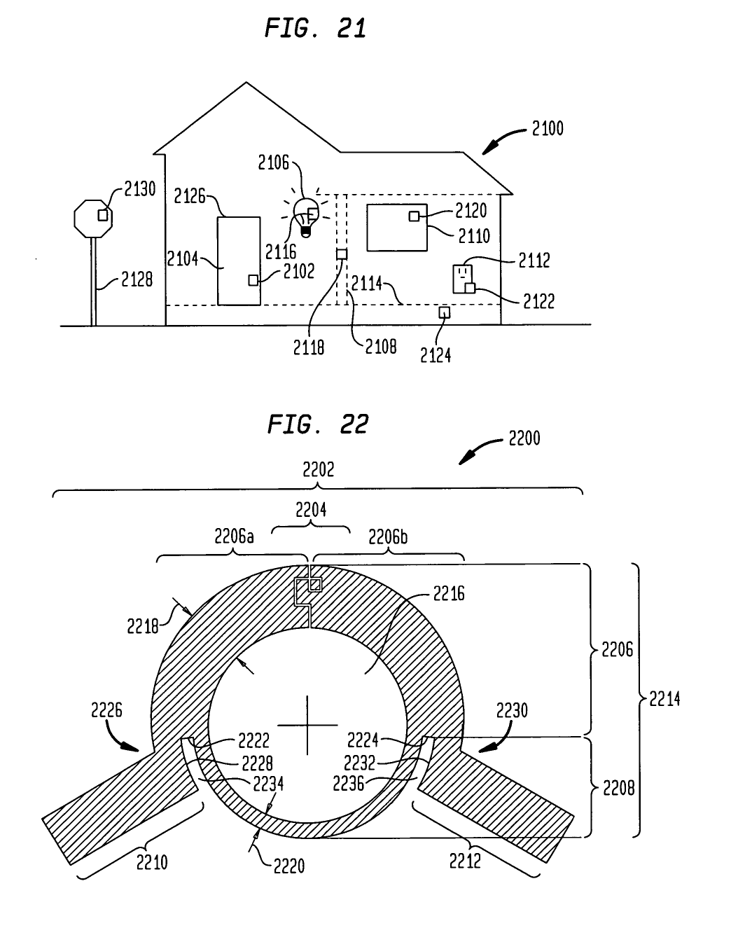

FIG. 22 shows an example quadraposer substrate 2200 for optical storage devices, according to an example embodiment of the present invention. As shown in FIG. 22, substrate 2200 has a conductive pattern 2202. Conductive pattern 2202 is planar, and includes a die mount position 2204, a first half circle portion 2206, a second half circle portion 2208, a first rectangular portion 2210, and a second rectangular portion 2212.

First and second half circle portions 2206 and 2208 are connected together to form a ring 2214, enclosing an open circular area 2216. First half circle portion 2206 has a radial width 2218 that is greater than a radial width 2220 of second half circle portion 2208, and thus is thicker radially (e.g., approximately 3 times thicker), and has an edge that extends further outward. A side 2226 of a first end 2228 of first rectangular portion 2210 is coupled to a portion 2222 of a first end of first half circle portion 2208. First rectangular portion 2210 extends radially from ring 2214. A side 2230 of a first end 2232 of second rectangular portion 2212 is coupled to a portion 2224 of a second end of first half circle portion 2208. Second rectangular portion 2212 extends radially from ring 2214. First end 2228 of first rectangular portion 2210 is separated from ring 2214 by a first gap 2234. First end 2232 of second rectangular portion 2212 is separated from ring 2214 by a second gap 2236.

First half circle portion 2206 has electrically isolated first and second (e.g., left and right) portions 2206a and 2206b that are separated at die mount position 2204. Note that first half circle portion 2206 and second half circle portion 2208 form approximate half circles around open circular area 2216. In the example of FIG. 22, first half circle portion 2206 has a circumferential length that is slightly more than a half of ring 2214, and second half circle portion 2206 has a circumferential length that is slightly less than a half of ring 2214.

Die mount position 2204 is centrally located along first half circle portion 2206. Die mount position 2204 is configured to mount a die/chip having four pads. Die mount position 2204 includes a first land 2240a, a second land 2240b, a third land 2240c, and a fourth land 2240d. Lands 2204a-2204d are arranged in a square pattern, in a clockwise fashion. Land 2204a is located in an upper left corner of the square pattern, and is connected to first portion 2206a of first half circle portion 2206. Land 2240b is connected to second portion 2206b of first half circle portion 2206. Land 2240c is electrically isolated. Land 2240d is coupled to second portion 2206b by a conductive link around land 2240c.

Thus, a die/chip may be mounted to die mount position 2204 to form a quadraposer suitable for mounting to an optical storage medium. In an embodiment, quadraposer substrate 2200 may be mounted to an optical storage medium, such that open circular area 2216 is centered around the center of the optical storage medium. When mounted in this fashion, first and second rectangular portions 2210 and 2212 are electrically coupled to the disc metallization layer (such as by an electrically conductive adhesive material). Conductive pattern 2202 is configured to match an impedance of the disc metallization layer, and thus the disc metallization layer can act as an antenna for the resulting RFID enabled optical storage medium.

Conductive pattern 2202 can have various sizes. For example, in one embodiment, conductive pattern 2202 of FIG. 22 may have a width of 1.757 inches and a height of 0.983 inches. Furthermore, conductive pattern 2202 can be made from silver, a silver alloy, or other conductive material described elsewhere herein or otherwise known.

Refer to U.S. App. Publ. No. 20040251541-A1, titled “Method, System, And Apparatus For High Volume Assembly Of Compact Discs And Digital Video Discs Incorporating Radio Frequency Identification Tag Technology,” which is incorporated by reference in its entirety, for further details on example optical storage media, details on example manufacturing processes for forming optical storage media, and for forming RFID enabled optical storage media.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A radio frequency identification (RFID) item, comprising:
a resonant material of the item; and
an integrated circuit (IC) die electrically coupled to the resonant material, wherein the resonant material functions as an antenna for the IC die.

2. The RFID item of claim 1, wherein the item is a cigarette pack.

3. The RFID item of claim 2, wherein the cigarette pack includes a foil sheet, wherein the foil sheet comprises said resonant material.

4. The RFID item of claim 3, wherein said IC die is mounted to said foil sheet.

5. The RFID item of claim 3, further comprising a quadraposer layer attached to said foil sheet, wherein said IC die is mounted to said quadraposer layer, wherein said IC die is electrically coupled to the foil sheet through the quadraposer layer.

6. The RFID item of claim 3, wherein said foil sheet has a slot formed therethrough, wherein said slot is sized to adjust a resonant frequency of said foil sheet.

7. The RFID item of claim 1, wherein the item is one of a bag, a window, a car windshield, a license plate, a boat, an electrical outlet, and a building.

8. The RFID item of claim 1, further comprising:
a substrate having a conductive pattern, wherein the IC die is mounted on the substrate and is electrically coupled to the conductive pattern, wherein the conductive pattern electrically couples the IC die to the resonant material.

9. The RFID item of claim 8, wherein the conductive pattern is configured to match an impedance characteristic of the resonant material.

10. The RFID item of claim 8, wherein the conductive pattern includes a plurality of electrically conductive segments.

11. The RFID item of claim 10, wherein an electrically conductive segment of the plurality of electrically conductive segments electrically couples a pad of the IC die to the resonant material.

12. The RFID item of claim 1, wherein a packaging of the item includes the resonant material.

13. The RFID item of claim 12, wherein the packaging is one of a bottle, a can, a vitamin container, a medicine container, a packaging for an optical storage medium, a packaging for a toy, a packaging for an appliance, or a packaging for a cosmetic.

14. The RFID item of claim 1, wherein the item is a consumer good.

15. The RFID item of claim 14, wherein the consumer good is one of a shoe, an article of clothing, a credit card, or a handheld electronic device.

16. The RFID item of claim 1, wherein the item is a sign, a doorway, a, locking mechanism, a light fixture, a house wiring; a flooring material, a window, a windshield, a wheel, a license plate, or a statue.

17. The RFID item of claim 1, wherein the item is an optical storage medium.

18. The RFID item of claim 17, wherein the optical storage medium is a compact disc (CD) or a digital video disc (DVD).

19. A method for forming a radio frequency identification (RFID) enabled item, comprising:
characterizing an item to determine an impedance characteristic;
forming a quadraposer to match the impedance characteristic; and
integrating the quadraposer with the item.

20. The method of claim 19, wherein said forming a quadraposer to match the impedance characteristic comprises:
mounting an integrated circuit die to a substrate having a conductive pattern.

21. The method of claim 20, wherein said integrating the quadraposer with the item comprises:
attaching the quadraposer to the item.

22. The method of claim 20, wherein said integrating the quadraposer with the item comprises:
inserting the quadraposer in the item.

23. The method of claim 20, wherein said integrating the quadraposer with the item comprises:
forming the item such that the quadraposer is in the object.

24. The method of claim 20, wherein said integrating the quadraposer with the object comprises:
attaching the quadraposer to packaging of the object.

25. The method of claim 20, wherein said forming a quadraposer to match the impedance characteristic further comprises:
configuring the conductive pattern to match the impedance characteristic.

26. The method of claim 25, wherein said configuring the conductive pattern to match the impedance characteristic comprises:
forming the conductive pattern to have a determined size.

27. The method of claim 25, wherein said configuring the conductive pattern to match the impedance characteristic comprises:
forming the conductive pattern to have a determined shape.

28. The method of claim 25, wherein said configuring the conductive pattern to match the impedance characteristic comprises:
forming the conductive pattern to have a determined thickness.

29. The method of claim 25, wherein said configuring the conductive pattern to match the impedance characteristic comprises:
forming the conductive pattern from a selected conductive material.

30. A radio frequency identification (RFID) enabled item, comprising:
a quadraposer means comprising an electrical circuit means and an interface means, wherein the interface means interfaces the electrical circuit means with a resonant material of the item, wherein said interface means matches an impedance characteristic of the resonant material.

31. The RFID enabled item of claim 30, wherein the interface means includes a substrate means.

32. The RFID enabled item of claim 31, wherein the substrate means includes a conductive pattern.

33. The RFID enabled item of claim 31, wherein the electrical circuit means includes an integrated circuit (IC) die.
